(19) United States
(12) Patent Application Publication
(10) Pub. No.: US 2003/0136052 A1
(43) Pub. Date: Jul. 24, 2003

(54) Revolving door

(76) Inventor: Martinus Hielke De Boer, Edam (NL)

Correspondence Address: PEACOCK MYERS AND ADAMS P C, P O BOX 26927, ALBUQUERQUE, NM, 871256927

(21) Appl. No.: 10/227,366

(22) Filed: Aug. 22, 2002

Related U.S. Application Data
(63) Continuation of application No. PCT/NL01/00162, filed on Feb. 26, 2001.

(30) Foreign Application Priority Data
Feb. 25, 2000 (NL) 1014503

(51) Int. Cl. E05D 15/02

(52) U.S. Cl. 49/42

(57) ABSTRACT

The invention relates to a revolving door, comprising a stationery cylinder accommodated in a wall and a rotatable partition dividing the cylinder substantially into two sections, comprising a wall element centrally positioned in the cylinder. The revolving door is embodied such that in, at or on the partition one or more means for the detection of inadmissible goods are provided.

The invention relates to a revolving door comprising a stationary cylinder accommodated in a wall, and a rotatable partition dividing the cylinder substantially into two sections, comprising a wall element centrally positioned in the cylinder.

Such a revolving door is known in practice and is used, for example, in shopping centres, large specialist shops, airports, and the like. Especially in the case of the revolving door being used at airports, it is expedient that no inadmissible goods can be taken through the revolving door.

In this connection a revolving door is provided in accordance with the invention, which is characterized in that the same is embodied such that in, at or on the partition one or more means for the detection of inadmissible goods are provided. By this means it is possible to detect whether weapons, bombs or other objects are being smuggled through the door.

Depending on the degree of protection desired various measures may be taken which will be elucidated successively hereinbelow.

In a first embodiment the revolving door according to the invention is characterized in that the same comprises a sensor, preferably an infrared sensor mounted near the periphery of the partition. By means of this sensor it is possible to detect whether someone standing outside the door extends his arm into the cylinder to stick an undesirable object on a panel of the wall element.

In a second embodiment of the revolving door according to the invention, in which the partition has a ceiling that is fixed in relation to, and revolves together with said wall panel, a downward directed sensor is, or downward directed sensors are, mounted in the ceiling near the wall element. By means of said sensors it is possible to scan the wall element in order to inspect it very carefully as to whether anything is stuck to the wall panel. In accordance with the requirements, the sensor may to a greater or lesser degree be placed such that the respective wall element is scanned completely or partially.

In a third embodiment of the revolving door according to the invention, the same is characterized in that a passive infrared sensor for the detection of a temperature change per unit of time is mounted in the ceiling at a predetermined distance from the wall element. Said sensor serves primarily to detect the presence of persons in the revolving door, but also to detect, for example, a hand weapon that was carried on the body and that was subsequently thrown into the door.

In a fourth embodiment of the revolving door according to the invention, the same is characterized in that one or more sensors are mounted in the ceiling, preferably of the ultrasonic or radar type. By means of such sensors objects lying on the floor can be detected to, for example, 1 cm from the floor, so that it is possible also to detect thin objects such as hand weapons.

In a fifth embodiment of the revolving door according to the invention, the same is characterized in that near the floor the partition is provided with one or more preferably infrared sender/receiver combinations. This system, too, is suitable for the detection of objects placed on the floor of the revolving door.

Preferably each sender/receiver combination is embodied with one sender and at least three receivers. This measure provides a relatively robust means of detection so that false alarms are avoided as much as possible. This is achieved especially in the embodiment wherein the sender/receiver combination emits a detection signal only when the receivers are activated simultaneously or sequentially.

In a sixth embodiment of the revolving door according to the invention, the same is characterized in that sensors are mounted in the floor detecting a presence. By means of these it is not only possible to detect the presence of persons, but it is also possible to detect whether said persons are moving in a desired direction. This is achieved in particular in the embodiment, in which the sensors of a presence are separately activated, substantially abutting pressure pads.

The objectives of the invention may be achieved in all the embodiment variants discussed especially if the revolving door is provided with a control unit with which the detection means are connected and which, subject to said detection means and the actual position of the revolving door, determines the subsequent movement of the revolving door.

The invention will now be elucidated with reference to a drawing illustrating a non-limiting exemplary embodiment of a revolving door according to the invention.

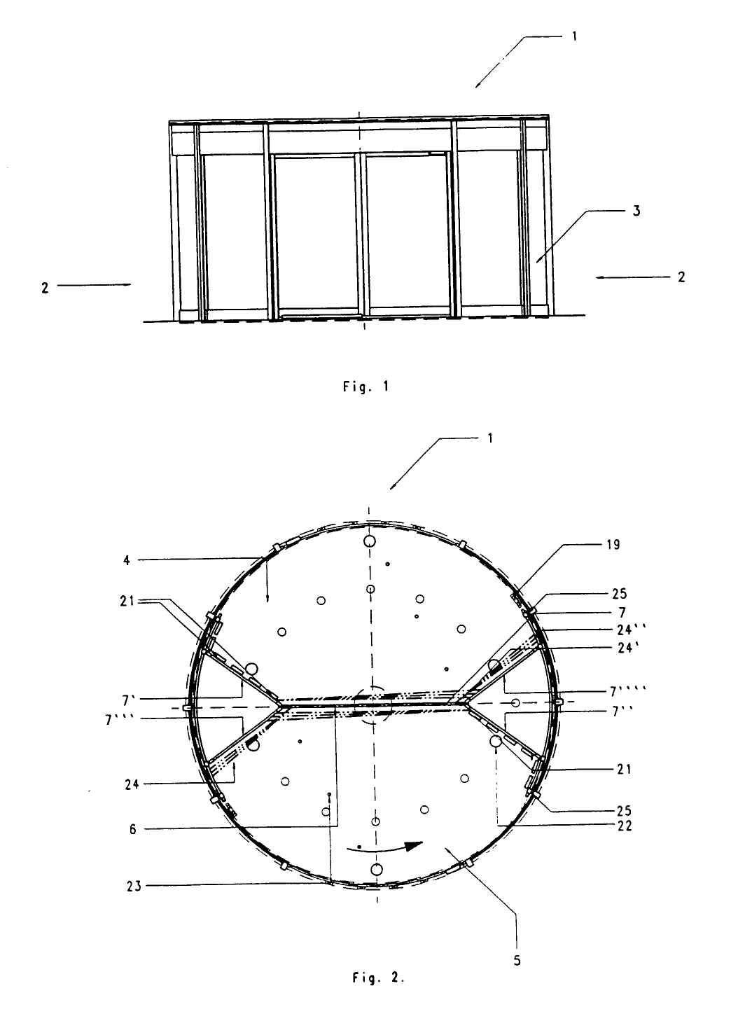

FIG. 1, shows a side view of the revolving door according to the invention; and

FIG. 2, shows a cross section of the revolving door according to the invention according to the line B-B in FIG. 1.

Identical reference numbers used in the figures refer to identical components.

Referring first to FIG. 1, the basic configuration of a revolving door 1 according to the invention is shown. Said revolving door 1 is accommodated in a wall 2 extending at both sides of the revolving door 1, and is formed by a stationary cylinder 3, and a rotatable partition 6 dividing the cylinder 3 substantially into two sections 4 and 5 and comprising a wall element 7, centrally positioned in the cylinder. The partition further has a ceiling (not shown) that is fixed in relation to, and revolves together with said wall panel 7. So far, the revolving door according to the invention corresponds with the prior art. A distinguishing feature compared with the prior art is that the revolving door 1 is embodied with a partition 6, in, at or on which one or more detection means for detecting inadmissible goods are provided. A part of said detection means is formed by a sensor 19, preferably an infrared sensor, being mounted near the periphery of the partition. Said sensor is usually embodied to revolve with the door and is located at both sides of the revolving door, so that section 5, to which the revolving door 1 gives access, is continually guarded at the access side of the door.

FIG. 2 further shows that in the ceiling near the wall element 7, and in particular in the sloping portion 7′ and 7″, the partition 6 is provided with downward directed sensors 21. These sensors, located in the rotatable part of the partition, inspect the area immediately in front of the wall elements 7′, 7″, so that if, for example, a weapon were stuck to said wall elements, this would be detected. Naturally the sensors 21 may also be located near the panels 7, 7′″ and 7″″. The wall element 25 provided in the periphery of the rotating part, adjacent the triangular showcases between the wall elements 7″, 7″″ and 7′, 7′″, is preferably also provided with such sensors. The figure further illustrates the application of a passive infrared sensor 22, by means of which a temperature change per unit of time can be detected. Said sensor 22 thus not only detects the presence of a person in the revolving door 1, but can also react to, for example, a hand weapon that was carried on the body thereby acquiring a different temperature than the ambient temperature, and which weapon has subsequently been thrown into the door. Reference number 23 indicates an ultrasonic sensor mounted in the ceiling. Such an ultrasonic sensor is arranged such that it emits sound in downward direction, and measures the time needed for the reflected sound to arrive again at the sensor. Goods that have been placed on the floor of the revolving door 1 are detected by means of possible deviations in reflection time. Even rather thin objects can be detected by means of such an ultrasonic sensor 23. One thing and another depends on the frequency of the sound that is emitted, but in practice objects having a thickness of approximately 1 cm can be detected effectively. Reference number 24 indicates that near the floor the partition is provided with an infrared sender/receiver combination. The figure shows four such sender/receiver combinations, two of which are located at both sides of the wall element 7, one is located near element 7′″, and one is located near wall element 7″″. Preferably, each sender/receiver combination 24 comprises one sender 24′ (see the combination located at panel 7″″) and three receivers 24″. Each sender/receiver combination is preferably wired such that the same emits a detection signal only when the receivers 24″ are activated simultaneously or sequentially. Preferably, the revolving door 1 according to the invention is further embodied such that sensors of a presence are mounted in the floor, which are preferably embodied as separately activated and substantially abutting pressure pads, by means of which the presence of persons in the revolving door 1 can be detected, as well as the direction of movement of said persons. Said pressure pads are not shown in the drawing. Likewise not shown, but completely obvious to the person skilled in the art, is the preferred embodiment of the revolving door 1 according to the invention, characterized in that the same is provided with a control unit to which the detection means elucidated in the foregoing are connected. Said control unit preferably operates such that the subsequent movement of the revolving door, i.e. facilitating the rotation of the revolving door, locking the revolving door, or causing the revolving door to rotate in the opposite direction, is determined subject to the detection means and the current position of the revolving door.

What is claimed is:

1. A revolving door comprising a stationary cylinder accommodated in a wall and a rotatable partition dividing the cylinder substantially into two sections comprising a wall element centrally positioned in the cylinder, wherein the same is embodied such that in, at or on the partition one or more means for the detection of inadmissable goods are provided.

2. A revolving door according to claim 1, wherein the detection means comprises a sensor.

3. A revolving door according to claim 2, wherein the sensor is an infrared sensor mounted near the periphery of the partition.

4. A revolving door according to claim 2, in which the partition has a ceiling that is fixed in relation to, and revolves together with, said wall element, wherein one or more downward directed sensors are mounted in a ceiling near the wall element.

5. A revolving door according to claim 2, wherein a passive infrared sensor for detection of a temperature change per unit of time is mounted in a ceiling at a predetermined distance from the wall element.

6. A revolving door according to claim 2, wherein one or more sensors are mounted in a ceiling.

7. A revolving door according to claim 6, wherein the one or more sensors mounted in a ceiling comprise one or more sensors from the group consisting of ultrasonic and radar sensors.

8. A revolving door according to claim 1, wherein near a floor the partition is provided with one or more infrared sender/receiver combinations.

9. A revolving door according to claim 8, wherein each sender/receiver combination is embodied with one sender and at least three receivers.

10. A revolving door according to claim 9, wherein each sender/receiver combination emits a detection signal only when the receivers are activated simultaneously or sequentially.

11. A revolving door according to claim 2, wherein sensors are mounted in a floor to detect a presence.

12. A revolving door according to claim 11, wherein the sensors of a presence are separately activated, substantially abutting pressure pads.

13. A revolving door according to claim 1, wherein a control unit is provided to which the detection means are connected and which, subject to said detection means and current position of the revolving door, determines further movement of the revolving door.
